(19) United States
(12) Patent Application Publication
(10) Pub. No.: US 2013/0235349 A1
(43) Pub. Date: Sep. 12, 2013

(54) COLOR WHEEL MODULE FOR USE IN A PROJECTION APPARATUS, PROJECTION APPARATUS, AND METHOD OF SWITCHING FOR DISPLAYING A STEREOSCOPIC IMAGE OR A FLAT IMAGE

(71) Applicant: Mao Shan HSU, Taoyuan-Hsien (TW)

(72) Inventor: Mao Shan HSU, Taoyuan-Hsien (TW)

(73) Assignee: DELTA ELECTRONICS, INC., Taoyuan-Hsien (TW)

(21) Appl. No.: 13/595,423

(22) Filed: Aug. 27, 2012

(30) Foreign Application Priority Data
Mar. 9, 2012 (TW) 101107986

(51) Int. Cl. G02B 27/22; G03B 21/14; G02B 7/00

(52) U.S. Cl. 353/7; 359/889; 353/121

(57) ABSTRACT

The present invention discloses a color wheel module for use in a projection apparatus. The color wheel module includes a color wheel, a supporting device, a fixing device and an actuator. The fixing device is disposed on the supporting device and partially connects with the actuator. A guide track is disposed on the supporting device, and the fixing device positions the color wheel on the guide track. While the actuator drives the fixing device, the color wheel moves along the guide track.

This application claims priority to Taiwan Patent Application No. 101107986 filed on 9 Mar. 2012, which is hereby incorporated herein by reference in its entirety.

### CROSS-REFERENCES TO RELATED APPLICATIONS

Not applicable.

### BACKGROUND OF THE INVENTION

1. Field of the Invention

The present invention provides a projection apparatus with a color wheel module, and more particularly, to a projection apparatus capable of switching between displaying a stereoscopic image and a flat image.

2. Descriptions of the Related Art

Over recent years, digital light processing (DLP) projection systems have become mainstream in the projection apparatus market because of features such as high brightness, vivid colors, rapid response and light weight. In addition to the conventional DLP projection systems for displaying flat images, there are also DLP projection systems for use as stereoscopic displaying projection systems.

A typical DLP projection system employs a digital micro-mirror device (DMD) in conjunction with the fixed color wheel as its framework. When a light beam passes through the color wheel, the light beam will be transformed into a colored light beam whose color depends on the color region through which it passes. The colored light beam is usually red, green or blue. The colored light beam is then reflected by the DMD to a screen to form a flat image. A DLP projection system that performs color filtering in this way can provide vivid colors, while the DMD increases the response speed of the projection apparatus as compared to conventional projection apparatuses.

A pair of active eyeglasses must be used to display a stereoscopic image in a DLP. During the displaying process, a grayscale picture is inserted between two frames by the projection system, and the active eyeglasses switch between a left-eye shutter and a right-eye shutter when receiving the grayscale picture. For example, when a grayscale picture is received, the active eyeglasses determine that the left-eye shutter needs to be turned on and, then, a left-eye view-angle image is provided by a projection apparatus so that the user's left eye will receive the left-eye view-angle image. Although this projection method is commonly adopted, the active eyeglasses are expensive and switching between the shutters decreases the overall brightness.

Accordingly, it is important to design a projection apparatus that has a low cost and a simplified optical arrangement and can switch between displaying the stereoscopic image and the flat image without compromising the brightness.

### SUMMARY OF THE INVENTION

The present invention provides a color wheel module for use in a projection apparatus, which comprises a color wheel, a supporting device, a fixing device and an actuator. The fixing device is disposed on the supporting device and connected with the actuator. The supporting device comprises a guide track, while the fixing device positions the color wheel on the guide track of the supporting device. The actuator drives the fixing device to move the color wheel along the guide track.

The present invention also provides a projection apparatus, which comprises a light source, a light filtering element, a light modulator and a color wheel module. The light source generates a light beam, while the traveling path of the light beam is defined as a light path. The light filtering element is positioned in the light path to transform the light beam into a colored light. Furthermore, the projection apparatus of the present invention has two modes, namely, a stereoscopic image mode and a flat image mode. In the stereoscopic image mode, the actuator of the color wheel module moves the color wheel along the guide track so that the colored light passes through the color wheel and is transformed into a viewing light. The light modulator transforms the viewing light into a view-angle image. In the flat image mode, the actuator of the color wheel module moves the color wheel along the guide track and away from the colored light (i.e., away from the light path). Then, the colored light enters the light modulator and is transformed into a flat image.

The present invention further provides a method for switching between displaying the stereoscopic image or the flat image in the aforesaid projection apparatus. First, a choice is made in whether to display a stereoscopic image or a flat image. Then, the color wheel is moved accordingly. A stereoscopic image or a flat image will then be provided.

An objective of the present invention is to provide a projection apparatus that is economical and compact, has a high brightness and can switch between displaying a stereoscopic image and a flat image.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating an internal structure of a first embodiment of the present invention;

FIG. 2 is a schematic view illustrating the internal structure of the first embodiment of the present invention in a stereoscopic image mode;

FIG. 3 is a schematic view illustrating the internal structure of the first embodiment of the present invention in a flat image mode;

FIG. 4 is a schematic exploded view illustrating an embodiment of a color wheel module of the present invention;

FIG. 5 is a schematic exploded view of the color wheel module of FIG. 4 at another viewing angle; and

FIG. 6 is a flowchart diagram of a method of switching between displaying a stereoscopic image or a flat image according to the present invention.

### DESCRIPTION OF THE PREFERRED EMBODIMENT

In the following descriptions, the present invention will be explained with reference to embodiments thereof. The present invention provides a projection apparatus and a color wheel module for use in the projection apparatus. It shall be appreciated that in the following embodiments and attached drawings, the description of these embodiments is only for the purpose of illustration rather than limitation. Meanwhile, in the following embodiments and attached drawings, elements not directly related to the present invention are omitted from depiction; and the dimensional relationships among the individual elements in the attached drawings are illustrated only for the ease of understanding but not to limit the actual scale and size.

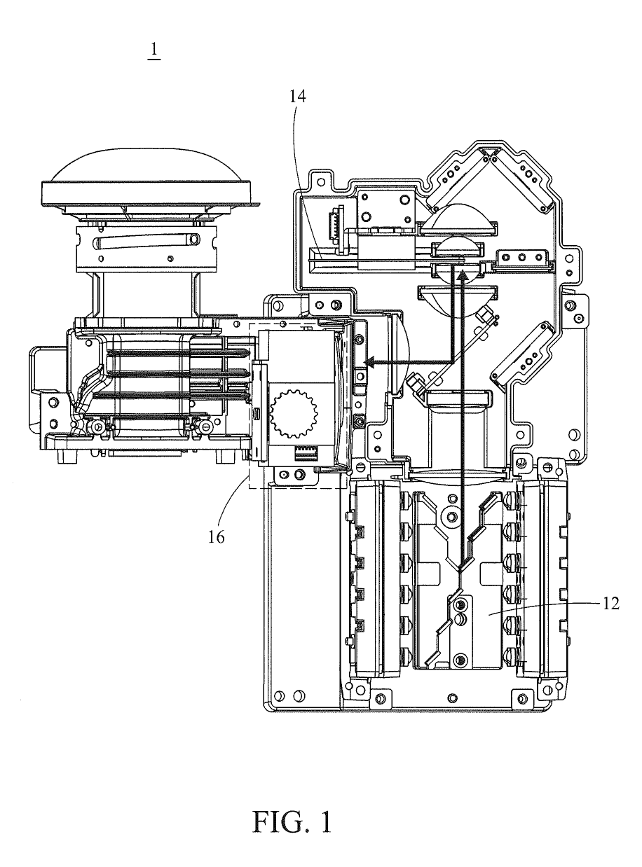

FIGS. 1 to 3 illustrate schematic views of an internal structure of the first embodiment of the present invention respectively. The projection apparatus 1 of the present invention comprises a light source 12, a light filtering element 14, a light modulator (not shown) and a color wheel module 16. The color wheel module 16 at least comprises an actuator 161 and a color wheel 162. When the light source 12 generates a light beam, the light beam is transformed into a colored light by the light filtering element 14.

In this embodiment, the light source 12 is a laser diode, the light filtering element 14 is a phosphor wheel, and the light modulator (not shown) is a digital micro-mirror device (DMD); however, in other embodiments, the light modulator may also be a liquid crystal display device.

In detail, the phosphor wheel may at least be divided into three phosphor index regions for stimulating different colored light beam. When the light beam is projected to one of the phosphor regions, the phosphor block will receive a light beam from the light source 12 and emit a stimulated light beam (i.e., the colored light) within a particular wavelength band. The light source 12 may also be an arc lamp, which works in conjunction with the color wheel to deliver an effect similar to what has been described above.

Furthermore, the projection apparatus 1 of the present invention works in two modes, namely, a stereoscopic image mode and a flat image mode.

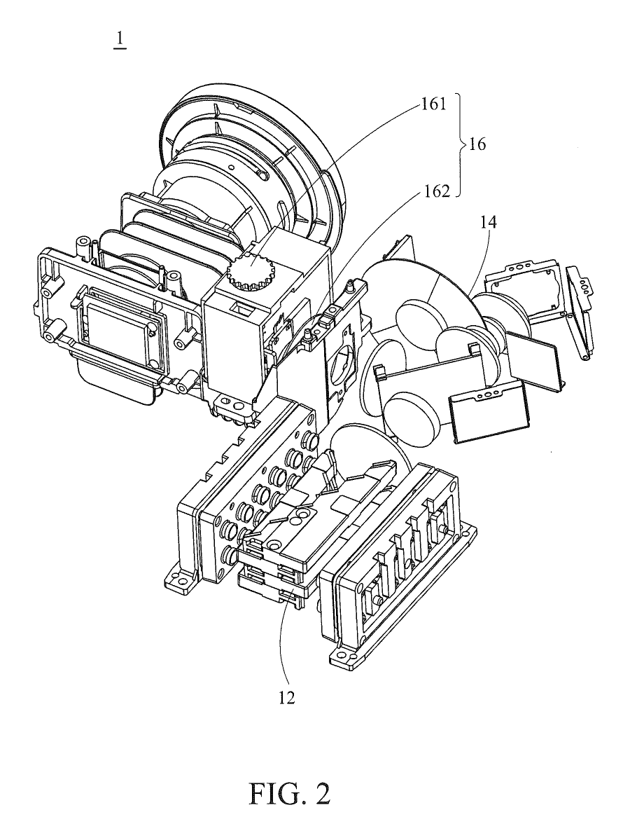

With reference to FIG. 2, in the stereoscopic image mode, the actuator 161 of the color wheel module 16 moves the color wheel 162 so that the colored light passes through the color wheel 162 and is transformed into a viewing light. Finally, the light modulator transforms the viewing light into a view-angle image. In detail, each index region of the color wheel 162 is further subdivided into a left view-angle block and a right view-angle block (not shown) for manipulating an output image into a left view-angle image and a right view-angle image respectively. Thereby, a stereoscopic image can be viewed by a viewer simply by wearing a pair of passive eyeglasses.

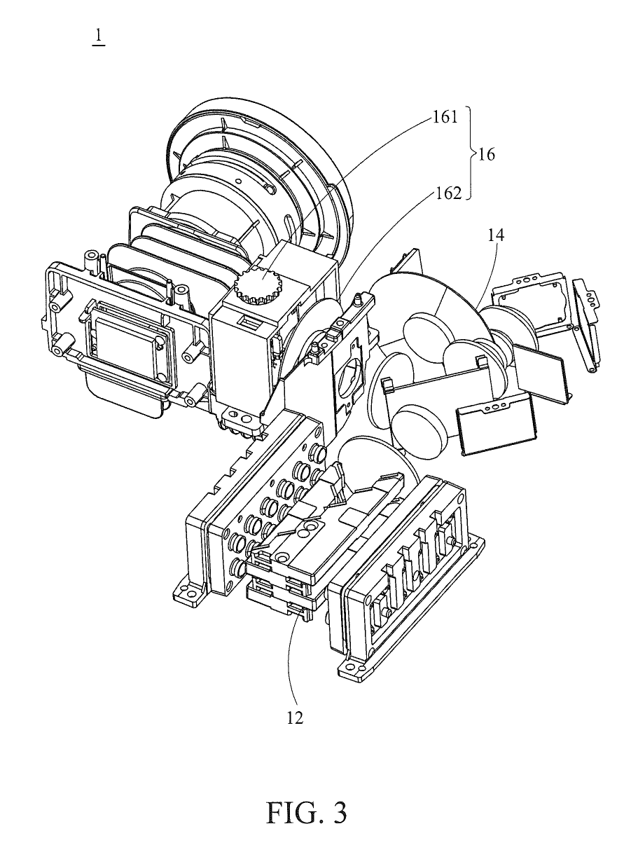

With reference to FIG. 3, when the projection apparatus 1 is in the flat image mode, the actuator 161 of the color wheel module 16 moves the color wheel 162 away from the colored light (i.e., the colored light does not pass through the color wheel 162). Finally, the light modulator directly transforms the colored light into a flat image that is formed on a screen.

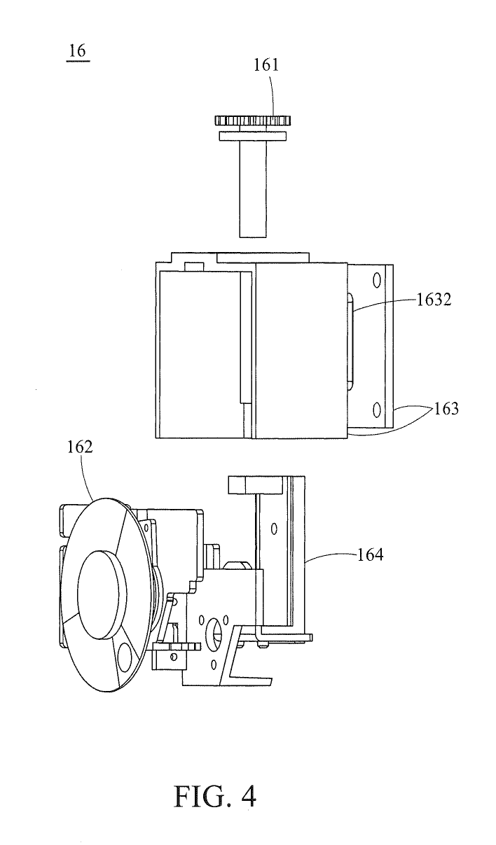

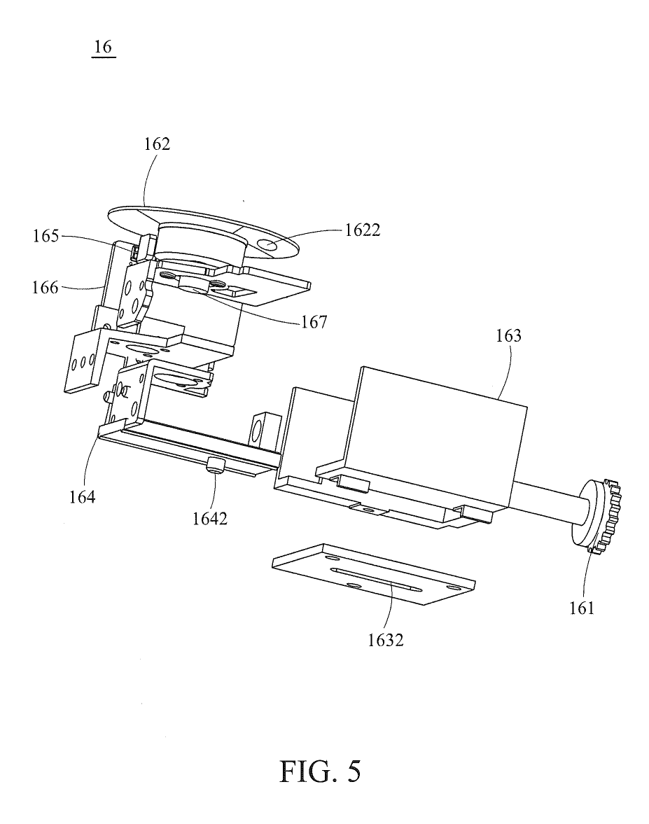

Next, the color wheel module 16 will be described in detail hereinbelow. FIGS. 4 and 5 show schematic exploded views illustrating the color wheel module 16 of the present invention. The color wheel module 16 comprises an actuator 161, a color wheel 162, a supporting device 163 and a fixing device 164. In this embodiment, the fixing device 164 clamps the color wheel 162, and positions the color wheel 162 on a guide track 164 of the supporting device 163 by means of a stopper 1642. In order for the actuator 161 to move the fixing device 164, the fixing device 164 and the actuator 161 are partially connected with each other.

In this embodiment, the actuator 161 is a screw rod. The color wheel 162 is moved along the guide track by moving the screw rod. The screw rod may also be replaced with a connecting rod. In some embodiments, the screw rod may also be replaced with a motor. When a motor is used as the actuator, a detecting device may further be used so that the color wheel is moved along the guide track according to the detecting device.

With reference to FIG. 5 again, the color wheel 162 is connected with a driving device 167, which is disposed on the fixing device 164 to drive and rotate the color wheel 162. The driving device 167 may be a motor. The driving device 167 enables the light beam to pass through a left-eye view-angle index region or a right-eye view-angle index region in a specific index mark of the color wheel 162 to generate a left-eye view-angle image or a right-eye view-angle image.

The color wheel module 16 further comprises an index board 165 and a light blocking plate 166 at the side of the color wheel 162. The index board 165 is disposed on the light blocking plate 166 to discern the color of the index region of the color wheel 162 through which the light beam passes and to feed this signal back to the motor so that the colorwheel's 162 rotation is controlled. The purpose of disposing a light blocking plate 166 is to reduce the influence of the light source on the index board 165. In this embodiment, the color wheel 162 further comprises a light passing hole 1622 to increase the brightness.

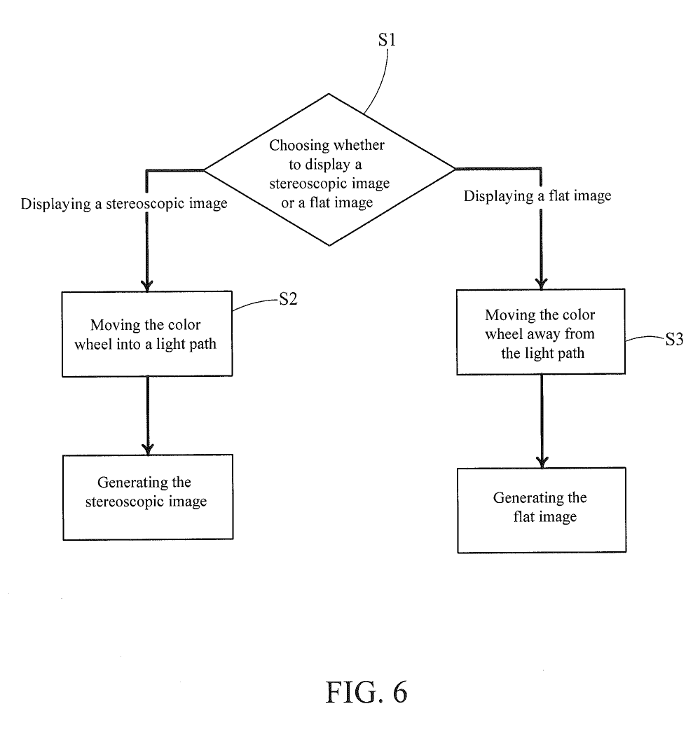

Finally, FIG. 6 illustrates the flowchart diagram of a method of switching between displaying a stereoscopic image or a flat image according to the present invention. First, it is determined whether to display a stereoscopic image or a flat image (step S1), and then a color wheel is moved according to the choice. In detail, if a stereoscopic image is to be displayed, then step S2 is executed to move the color wheel into a light path for imaging in a projection apparatus. For example, after the color wheel 162 is moved, the light beam passes through the light filtering element 14 and the color wheel 162 sequentially and finally forms the stereoscopic image on a screen (not shown). On the other hand, if a flat image is to be displayed, then step S3 is executed to move the color wheel 162 away from the light path. In this case, the light beam passes through only the light filtering element 14 without passing through the color wheel 162, and forms the flat image on the screen (not shown).

According to the above descriptions, a color wheel module of the present invention can control and move a color wheel disposed therein. Thereby, when the color wheel module is applied to a projection apparatus, a light beam can be controlled to pass or not pass through the color wheel. Thereby, a projection apparatus that is economical and compact, has high brightness and can switch between displaying a stereoscopic image and a flat image can be provided.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A color wheel module for use in a projection apparatus, comprising:
a color wheel;
a supporting device, comprising a guide track;
a fixing device, being disposed on the supporting device and positioning the color wheel on the guide track of the supporting device; and
an actuator, being connected with the fixing device;
wherein the actuator drives the fixing device to move the color wheel along the guide track.

2. The color wheel module as claimed in claim 1, wherein the actuator is a motor.

3. The color wheel module as claimed in claim 1, wherein the actuator is a connecting rod.

4. The color wheel module as claimed in claim 1, wherein the actuator is a screw rod.

5. The color wheel module as claimed in claim 1, further comprising an index board disposed next to the color wheel to read an index mark of the color wheel.

6. The color wheel module as claimed in claim 5, further comprising a light blocking plate on which the index board is disposed.

7. The color wheel module as claimed in claim 1, wherein the color wheel comprises a light passing hole.

8. The color wheel module as claimed in claim 1, further comprising a driving device disposed on the fixing device to drive the color wheel.

9. The color wheel module as claimed in claim 8, wherein the driving device is a motor.

10. The color wheel module as claimed in claim 1, wherein the fixing device further comprises a stopper mounted in the guide track.

11. A projection apparatus, comprising:
a light source, generating a light beam;
a light filtering element, positioned in a light path of the light beam and transforming the light beam into a colored light;
a light modulator; and
a color wheel module, comprising:
a supporting device, comprising a guide track;
a fixing device, being disposed on the supporting device and positioning the color wheel on the guide track of the supporting device; and
an actuator, being connected with the fixing device;
wherein, in a stereoscopic image mode, the actuator of the color wheel module moves the color wheel along the guide track so that the colored light passes through the color wheel and is transformed into a viewing light, and then the light modulator transforms the viewing light into a view-angle image; and in a flat image mode, the actuator of the color wheel module moves the color wheel along the guide track and away from the light path, and then the colored light enters the light modulator and is transformed into a flat image.

12. The projection apparatus as claimed in claim 11, wherein the light filtering element is a color wheel.

13. The projection apparatus as claimed in claim 11, wherein the light filtering element is a phosphor wheel.

14. The projection apparatus as claimed in claim 11, wherein the light modulator is a digital micro-mirror device.

15. The projection apparatus as claimed in claim 11, wherein the light modulator is a liquid crystal display device.

16. The projection apparatus as claimed in claim 11, wherein the light source is a laser diode.

17. The projection apparatus as claimed in claim 11, wherein the light source is an arc lamp.

18. A method of switching for displaying a stereoscopic image or a flat image in a projection apparatus, wherein the projection apparatus comprises a light source, a light filtering element and a color wheel, and the light filtering element is disposed in a light path of a light beam generated by the light source, the method comprising:
(a) choosing to display a stereoscopic image or a flat image; and
(b) moving the color wheel according to the step (a).

19. The method as claimed in claim 18, wherein the step (a) chooses to display a stereoscopic image, and then in the step (b), the color wheel is moved into the light path, and the light beam then passes through the light filtering element and the color wheel sequentially to form the stereoscopic image on a screen.

20. The method as claimed in claim 18, wherein the step (a) chooses to display a flat image, and then in the step (b), the color wheel is moved away from the light path, and the light beam then passes through the light filtering element to form the flat image on a screen.
